(19) United States
(12) Patent Application Publication
(10) Pub. No.: US 2025/0377792 A1
(43) Pub. Date: Dec. 11, 2025

(54) COMPUTATIONAL MEMORY

(71) Applicant: Micron Technology, Inc., Boise, ID (US)

(72) Inventors: Craig William Warner, Coppell, TX (US); John M. Groves, Austin, TX (US)

(21) Appl. No.: 19/219,297

(22) Filed: May 27, 2025

Related U.S. Application Data
(60) Provisional application No. 63/658,249, filed on Jun. 10, 2024.

(51) Int. Cl. G06F 3/06

(52) U.S. Cl. CPC G06F 3/0611; G06F 3/0659; G06F 3/0679

(57) ABSTRACT

The disclosed memory architecture eliminates the need for the conventional queue-based work request model by allowing direct computation within memory modules in response to data writes. The system is designed to automatically update computed values, such as hashes, within a designated computational memory region in response to a write to a corresponding data set region, without explicit instructions from the host. The computation happens according to a defined policy, which may include computing a new result immediately after a write to a dataset segment, computing the result if no writes are detected to a dataset segment within a specified period of time, computing the result after a host reads an invalid compute validity bit, or the like.

### PRIORITY APPLICATION

This application claims the benefit of priority to U.S. Provisional Application Ser. No. 63/658,249, filed Jun. 10, 2024, which is incorporated herein by reference in its entirety.

### TECHNICAL FIELD

Embodiments pertain to memory devices with computational capabilities. Some embodiments relate to methods for providing computational capabilities in memory devices.

### BACKGROUND

Memory devices for computers or other electronic devices may be categorized as volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, phase-change memory, storage class memory, resistive random-access memory (RRAM), and magnetoresistive random-access memory (MRAM), among others. Persistent memory is an architectural property of the system where the data stored in the media is available after system reset or power-cycling. In some examples, non-volatile memory media may be used to build a system with a persistent memory model.

Memory devices may interface with a host, such as a host processor or another computing device, to store essential data, commands, and instructions for the operation of the host's system. The connection between the host and memory devices can be established via a local bus or interconnect, allowing the memory devices to function within the host's system such as within a traditional computing device. Alternatively, memory devices can be configured within a distributed memory system, which involves a network of interconnected hosts and memory devices which may span across multiple locations. This configuration enables the creation of expansive systems that harness the collective resources of numerous hosts and memory devices.

A distributed memory system facilitates communication and data sharing across multiple hosts and multiple memory devices by employing distributed communication fabrics that interlink multiple hosts and memory devices. This system is distinct from local memory configurations where memory devices are directly and physically connected to a single host.

Communication within distributed memory systems adheres to various protocols or standards designed to ensure efficient and reliable data exchange. For instance, the Compute Express Link (CXL) protocol is one such standard that offers high-bandwidth and low-latency connectivity, optimizing performance in distributed memory systems.

CXL.mem is a part of the CXL protocol that facilitates high-speed, efficient communication between a host processor and one or more memory devices. The architecture is characterized by its ability to provide a coherent memory space between the CPU and memory expansions, such as RAM modules or non-volatile memory, through the CXL interface. CXL.mem employs advanced features such as memory pooling, where memory resources can be dynamically allocated and deallocated across various processors and devices, and memory sharing, which allows multiple CPUs or accelerators to access the same physical memory concurrently. This architecture is designed to significantly reduce latency and increase bandwidth, thereby improving overall system performance. The CXL.mem architecture is also scalable, supporting a wide range of applications from data centers to high-performance computing environments. Its compatibility with existing and future CXL specifications ensures that it can be integrated into next-generation computing systems with minimal modifications.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a distributed memory system according to some examples of the present disclosure.

FIG. 2 illustrates a logical diagram of a compute-near memory system according to the present disclosure.

FIG. 3 illustrates a logical diagram of a memory address space according to some examples of the present disclosure.

FIG. 4 illustrates a timeline of a host accessing the compute results according to some examples of the present disclosure.

FIG. 5 illustrates a state machine for managing a compute validity bit associated with a compute region segment in a memory device according to some examples of the present disclosure.

FIG. 6 illustrates a block diagram of the unique hardware architecture for the Computational Memory Controller within a CXL memory device according to some examples of the present disclosure.

FIG. 7 illustrates a flowchart of a method of computational memory processing according to some examples of the present disclosure.

FIG. 8 is a block diagram illustrating an example of a machine upon which one or more embodiments may be implemented.

### DETAILED DESCRIPTION

In distributed memory systems, computational memory devices, also known as compute-near-memory devices, are an innovative class of memory systems that incorporate processing elements in close physical proximity to the memory cells. This design paradigm, which deviates from the traditional von Neumann architecture, embeds computational functions within the memory subsystem, allowing data processing to occur at or near the location where data is stored. This architectural innovation offers a multitude of benefits, primarily by mitigating the data transfer bottleneck commonly associated with traditional von Neumann architectures. By performing computations in close physical proximity to where the data is stored, computational memory devices reduce the latency and energy consumption that would otherwise be incurred during data movement between the processor and memory. The proximity between memory and compute allows for higher bandwidth and more efficient data throughput, enabling faster processing speeds for data-intensive applications such as machine learning, big data analytics, and real-time processing. In addition to higher bandwidth and more efficient data throughput, computational memory devices can lead to a reduction in the overall complexity of system design and can improve parallel processing capabilities by allowing multiple computations to occur simultaneously within the memory array. This design also facilitates better scalability, as adding more computational memory devices can directly increase the computational power without the need for extensive modifications to the central processing unit (CPU) or the system bus. Overall, computational memory devices offer a transformative approach to computing that can unlock new levels of performance and efficiency for a wide array of computing tasks.

Computational memory systems that include computational memory devices often rely on a traditional queue model, where a host processor sends work requests to memory modules (e.g., memory devices) to perform computational tasks. This model, while conceptually straightforward, introduces several inefficiencies that can significantly hinder system performance. One issue of this model is the latency associated with the back-and-forth communication between the host and the memory modules. Each work request and subsequent response adds to the overall time required to complete computational tasks. Additionally, this model requires management of a queue of work requests, which can become a bottleneck in data-intensive applications, leading to underutilization of computational resources and increased energy consumption.

Another limitation of present systems is the complexity imposed on software developers, who must explicitly manage the tracking of memory stores and the corresponding computational tasks. This requirement not only complicates the development process but also increases the likelihood of programming errors. Developers must ensure that every time data is written to memory, any dependent computations are also triggered, which can be particularly challenging in systems with high levels of concurrency or when dealing with large datasets. The burden of tracking stores also extends to the handling of dirty data flags, further complicating the programming model and increasing the overhead of ensuring data consistency and integrity.

The prior art's queue-based approach to computational memory systems also presents challenges in scalability and flexibility. As the volume of data and the complexity of computational tasks grow, the queue model can struggle to keep up, leading to increased latency and reduced throughput. Moreover, the rigid nature of the queue system makes it difficult to adapt to different types of computational tasks or to efficiently allocate resources based on dynamic workloads. This inflexibility can result in suboptimal performance, particularly in heterogeneous computing environments where different types of computations may be required to operate on the same datasets.

Disclosed in some examples are methods, systems, memory devices, and machine-readable mediums for providing more efficient computational memory systems. The disclosed memory architecture eliminates the need for the conventional queue-based work request model by allowing direct computation within memory modules in response to writing of the arguments of the computation to a defined memory location. The results of the computation are then stored in another defined location that may correspond to the defined memory location where the arguments are written.

The system is thus designed to automatically update computed values in a designated region without explicit instructions from the host in response to a write to a corresponding designated dataset region. The computation may occur according to a defined policy, which may include computing a new result immediately after a write to a dataset segment of the dataset region, computing the result if no writes are detected to a dataset segment within a specified period of time, computing the result after a host reads an invalid compute validity bit, or the like. Example computations may include hashes (e.g., SHA-256), calculating compressibility of data, pattern matching algorithms to find the number of occurrences and locations of patterns within a dataset, tokenization of data sets, thumbnail image calculations, content analysis, and the like.

Computations may be prespecified and selectable by the host. In other examples, calculations may be customized by the host and the address of the instructions of the computation may be specified by the host. Computations may be performed by a general-purpose hardware processor using either predefined instructions or custom instructions of a host. In other examples, computations may be performed using custom hardware processors.

In some examples, to ensure the validity and integrity of the results in the computational memory, the architecture utilizes validity bits and a minimum recalculation period that allows the host systems to be confident that the results are valid for a set of inputs.

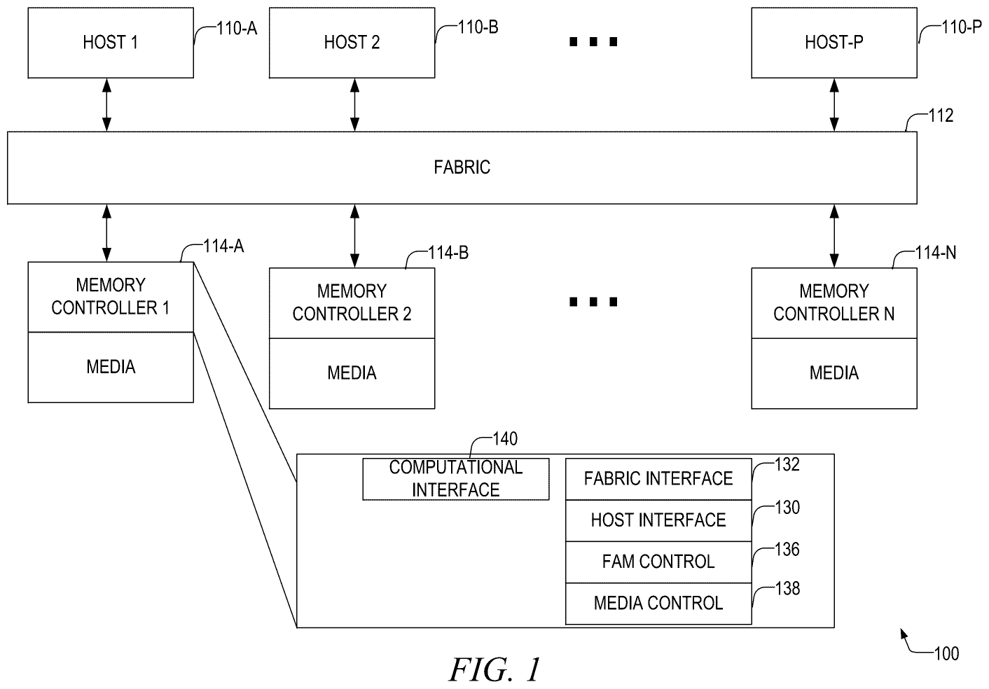

FIG. 1 illustrates a distributed memory system 100 according to some examples of the present disclosure. The distributed memory system 100 facilitates high-speed, efficient communication between hosts 110-A, 110-B . . . 110-P and one or more memory devices 114-A, 114-B . . . 114-N. The memory system 100 may provide a coherent memory space between processing elements on the hosts 110-A, 110-B . . . 110-P, such as a CPU or other hardware processor, and the memory devices 114-A-114-N. As an example, the distributed memory system 100 may be a CXL memory architecture according to a CXL.mem standard. Distributed memory system 100 may feature memory pooling, where memory resources can be dynamically allocated and deallocated across various processors and devices, and memory sharing, which allows multiple CPUs or accelerators to access the same physical memory concurrently.

Hosts 110-A, 110-B . . . 110-P are connected to the one or more memory devices 114-A, 114-B . . . 114-N using an interconnect fabric, such as a fabric 112. An interconnect fabric, such as fabric 112 is a network framework that enables the transfer of data between various components of a computing system, such as processors, memory modules, storage devices, and input/output peripherals. The fabric typically comprises interconnected nodes, switches, and communication links that facilitate the coherent and coordinated operation of a multi-component system, allowing for integrated performance and resource optimization.

In a distributed compute-near-memory system such as a CXL (Compute Express Link) system, the memory devices 114-A, 114-B . . . 114-N are equipped with memory controllers that not only manage the flow of data to and from the memory media but also facilitate computation tasks close to where data is stored. In FIG. 1, the memory controllers, such as memory controller 1 214-A, include components such as a host interface component 130, a CXL fabric interface component 132, a FAM (Fabric-Attached Memory) control component 136, and a media control component 138. These components can be realized through hardware, or a combination of hardware and software configuration.

The host interface component 130 is responsible for implementing protocols or interfaces that allow the memory controller to receive memory commands from the host, including data mover calls which are used for moving data efficiently within the system. The CXL fabric interface component 132 facilitates communication across the CXL fabric 112, enabling high-speed data transfer and coordination across the distributed memory system.

The media control component 138 manages memory operations such as read and write scheduling, refresh control to maintain data integrity in volatile memory types, and error-correcting code (ECC) for detecting and correcting data corruption. An example of this component is a DRAM controller, which specifically manages dynamic random-access memory operations.

The FAM control component 136 maintains address translation tables and access control tables. These tables are used to translate addresses between various forms and to route memory requests to the appropriate memory devices, ensuring efficient data access and security within the distributed memory architecture.

Furthermore, the memory controllers may also incorporate a computational interface 140. This interface implements the efficient computational memory system, enabling the execution of computational tasks such as data analytics, machine learning, and other processing directly within the memory modules according to the disclosed methods. For example, the computational interface 140 configures compute regions and dataset regions, monitors writes to the data set region, executes a policy in response to the writes, and executes compute logic to produce a result which is stored in a corresponding compute region. In addition, the computational interface 140 may manage the validity bits. By doing so, the computational interface 140 reduces the latency and bandwidth constraints associated with transferring data to a central processor, thereby enhancing overall system performance and efficiency in compute-near-memory operations.

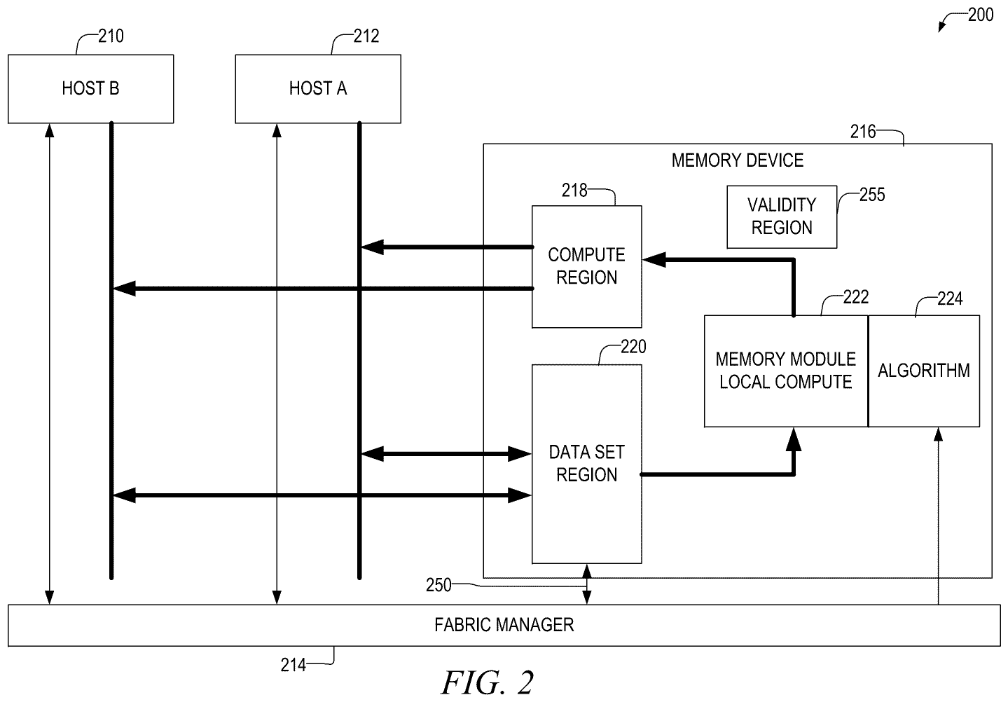

FIG. 2 illustrates a logical diagram 200 of a compute-near memory system according to the present disclosure. The memory device 216 may be an example of one of the memory device 114-A-114-N of FIG. 1. Host A 212 and Host B 210 may be examples of the hosts (such as Host 1 110-A, host 2 110-B . . . host-p 110-P) from FIG. 1. Memory device 216 may be in the form of a memory module with memory media and a memory controller. Memory device 216 may include volatile and/or non-volatile memory media. The memory device may allocate portions of the memory cells in the memory media to a dataset region 220 and a portion to a compute region 218. The dataset region 220 is a portion of memory that is designated for storing data intended as arguments for computational tasks. This region may be divided into fixed-length segments, with one or more segments (e.g., a single segment) corresponding to a segment in the compute region 218 where the computational results, performed on the arguments in the dataset region are stored.

In some examples, the dataset region 220 may be configured as a tagged capacity region, accessible to distributed hosts upon authorization by the fabric manager. When a host writes data to a segment within the dataset region 220, the associated memory device (e.g., the computational interface 140 of the memory controller) is responsible for automatically performing the designated computation and updating the corresponding segment of the compute region 218. For example, the memory module local compute 222 may perform the computations. In some examples, the memory module local compute 222 may be a general-purpose hardware processor configured to perform the computations according to one or more software programs. In other examples, the memory module local compute 222 may perform the computations in hardware.

When a host processor, such as host A 212, or host B 210 intends to access computational results in the compute region 218, it references the compute region based on the known structure and segment pairing. The host is aware of the starting address and segment size of both the dataset region 220 and the compute region 218, as these parameters are defined during the setup process managed by the fabric manager. By utilizing this information, the host can calculate the address of a particular segment in the compute region 218 that corresponds to a particular segment of the dataset region 220. For example, by using a fixed offset.

As previously described, writing to a segment in the dataset region 220 acts as a request to perform a computation defined by the computation algorithm. This removes the need for a formal request sent over the fabric. The calculations are then automatically performed when indicated by the defined policy and the result placed in the compute region 218. The computation algorithm performed may be a standard, prespecified algorithm, such as SHA-256 for hashing, or a custom algorithm for tasks like pattern matching or data tokenization. In some examples, the host may select from one of a plurality of prespecified algorithms, for example, by writing a value to the data set region that acts as a selection field or flag.

In other examples, the fabric manager 214 may be used to select the computational algorithm from a plurality of prespecified algorithms, e.g., using management mailbox commands. In some examples, customized algorithms may be loaded to a prespecified memory location. The code for the algorithm may be stored in the algorithm section 224 of the memory device, or, in the case of prespecified algorithms, the algorithm section 224 may be customized hardware which implements the prespecified algorithms in hardware.

In some examples, the mailbox commands 250 may be used to create the region pair of dataset region 220 and compute region 218. These mailbox commands 250 may also specify the computational algorithm to be used, along with other parameters such as segment size and the starting address for each region. Once the memory device 216 is configured, it actively monitors writes to the dataset region 220. Upon detecting a write, the memory device 216 may trigger the selected computational algorithm to process the new data and update the compute region 218 with the results.

As noted, the computation may be started in accordance with a compute start policy. In some examples, the policy can specify that the compute starts immediately upon data write, after a certain delay, or upon a specific request from the host. In some examples, the computation may be started when the host attempts to write to the corresponding segment in the compute region 218. The memory device 216 may intercept the write (and not actually allow the write to write to the memory), and then start the computation.

In some examples, the memory device includes a validity region 255 which may store validity bits for segments of the compute region 218. Validity region 255 may be SRAM, flip-flops, or other storage. In other examples, the validity region may be stored with the compute region 218.

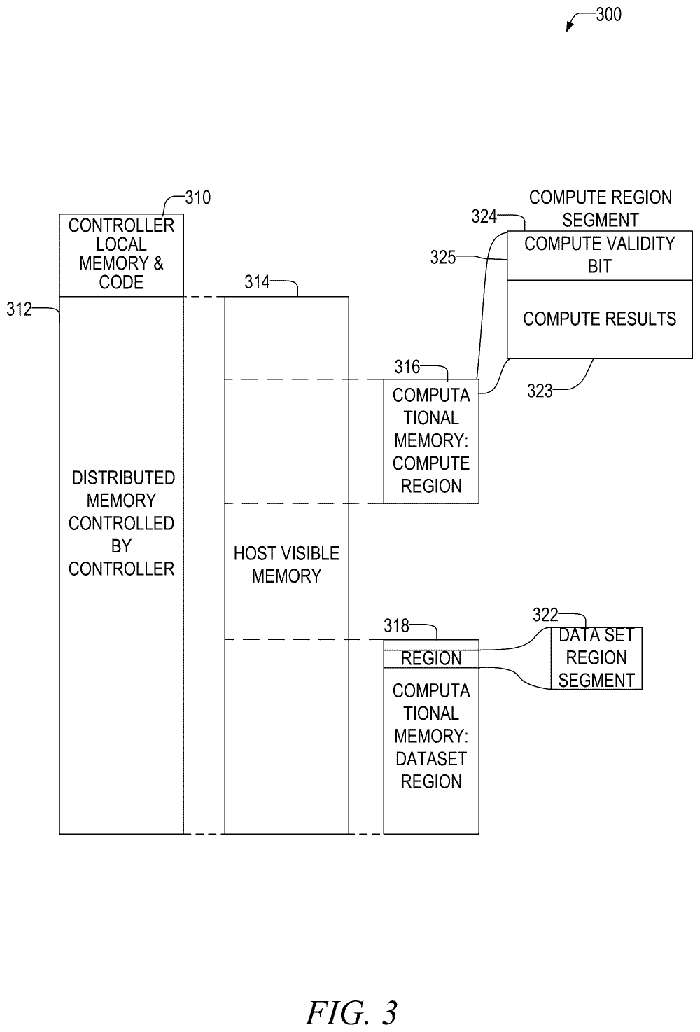

FIG. 3 illustrates a logical diagram of a memory address space 300 according to some examples of the present disclosure. Of the entire usable memory of the media, some memory is designated for controller use as controller local memory and code section 310. This may store firmware and other operating code and usable memory for that code used by the controller. The remaining memory 312 is distributed memory controlled by a memory controller. This memory may comprise the host visible memory 314. Of the host visible memory, two memory sections may be created for computational memory. A first memory section 316 which is a compute region for storing results. The compute region may be subdivided into compute region segments, such as the compute region segment 324. The compute region segment may include a compute validity bit 325 and the compute results 323. In some examples, the compute validity bit 325 may be stored in a different location, such as the controller local memory and code section 310, a cache, other memory of the controller, an on-die structure such as SRAM or flip-flops, or the like. The computational memory dataset region 318 may also be divided into segments 322. The size of segments 322 and segments 324 may be a same size, or different sizes. For example, the segments 322 may be larger than the segments 324 as the computational results may be smaller than the operands.

Hosts reading the compute region may utilize one or more processing algorithms to ensure the results are valid. In some examples, a simple results processing algorithm may be used for reading computational results from a compute region when the result size is equivalent to one cache line. In sum, this algorithm is to read the results in the compute region until the valid bit is true. In particular, the host first identifies the memory address of the compute region and prepares a local memory space to store a copy of the compute region. The host initiates a loop to poll the compute validity bit. Within the loop, the host flushes the cache line corresponding to the compute region address to ensure that the latest data is fetched directly from the memory module. The host then copies the cache line from the compute region to the local memory space and reads the compute validity bit. If the compute validity bit is false, indicating that the results are not yet valid, the loop continues, and the host retries the process. Once the compute validity bit is true, indicating that the results are valid, the host exits the loop and proceeds to use the data from the local copy of the compute region.

In other examples, a more general results reading algorithm for cases where the computational results span more than one cache line or when atomic cache line copy operations are not supported may be more complex. For example, the host may first initialize variables for the start and end times of the operation, the addresses of the compute region and a local memory space, and flags to track the validity of the results. The host enters a loop to read the computational results, which includes an inner loop to poll the compute validity bit. Within the inner loop, the host flushes the cache line corresponding to the compute region address to ensure it fetches the latest data directly from the memory module. The host then reads the compute validity bit from the compute region into the local memory space. If the compute validity bit is false, the inner loop continues, and the host retries the process. Once the compute validity bit is true, the host records the start time, flushes the entire compute region from the cache, and copies the computational results into the local memory space. The host then reads the compute validity bit a second time to ensure it has not changed during the read operation. The host records the end time of the operation and checks if the time taken to read the results is less than the compute minimum recalculation period and that both validity bit readings are true. If these conditions are met, the results are considered valid. If the conditions are not met, indicating that the results may have been invalidated during the read operation, the host sets a flag to false, and the outer loop continues, prompting a retry. Once the host successfully captures valid results, it exits the loop and proceeds to use the data from the local memory space. This algorithm ensures that the host reads coherent and trustworthy computational results by verifying the validity before and after the read operation and by adhering to the compute minimum recalculation period.

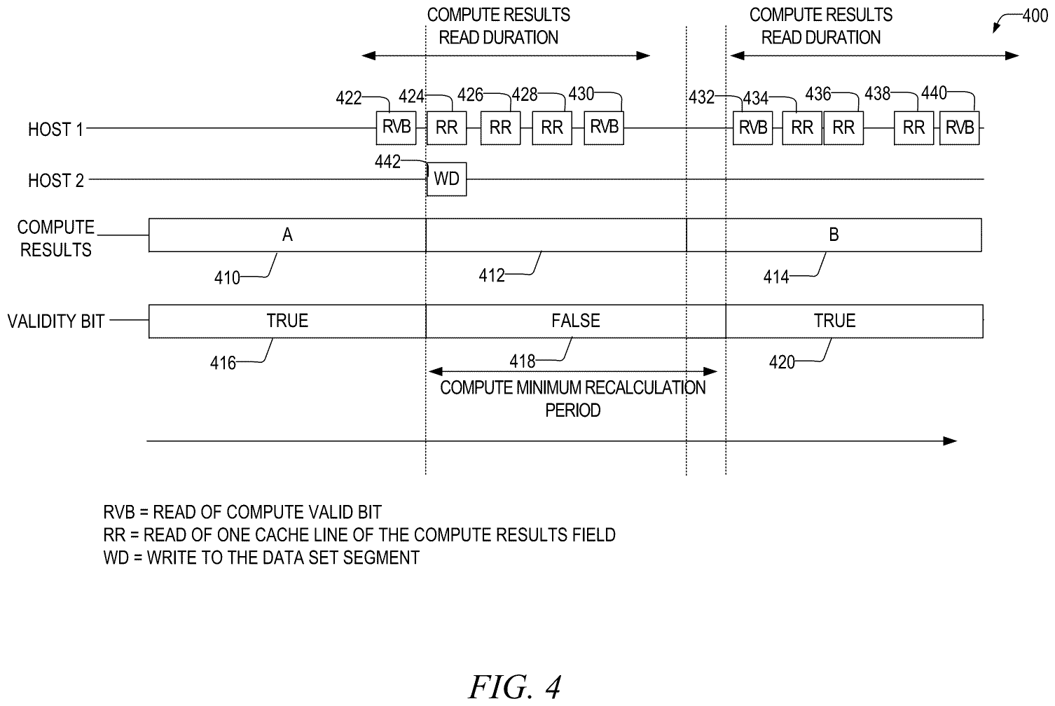

FIG. 4 illustrates a timeline 400 of a host accessing the compute results according to some examples of the present disclosure. FIG. 4 illustrates the more complex algorithm for reading results. The timeline 400 demonstrates the use of a compute minimum recalculation period and the validity bit to ensure that results read by a host are valid. As previously described, the compute validity bit is a flag stored within the memory controller or the memory, indicating whether the associated computational results are current and valid. The timeline 400 relates to a single computational memory pair of data set region and compute region. The compute results are initially set to the value “A” at 410 and the validity bit is TRUE 416. During this time, the host 1 reads the compute valid bit 422, finding it to be true. Shortly thereafter, host 2 writes to the dataset region causing the compute results to be undefined 412 and the validity bit to be cleared to FALSE 418. The host 1 continues to read the compute results at 424, 426, and 428. At 430, the host 1 reads the validity bit and finds it false. This means that the results read by host 1 is invalid.

The compute results are refreshed 414 to result B based upon the data written by host 2. Shortly thereafter the validity bit is set to true 420 upon expiration of the compute minimum recalculation period. Host 1 then re-reads the validity bit 432, finding it true 420. The results are then read at 434, 436, and 438. The host 1 then reads the validity bit 440 again, finding it true 420. Since the host read true for the validity bit before and after the result was read, and the duration of the read was less than the compute minimum recalculation period, the result of the read is valid data.

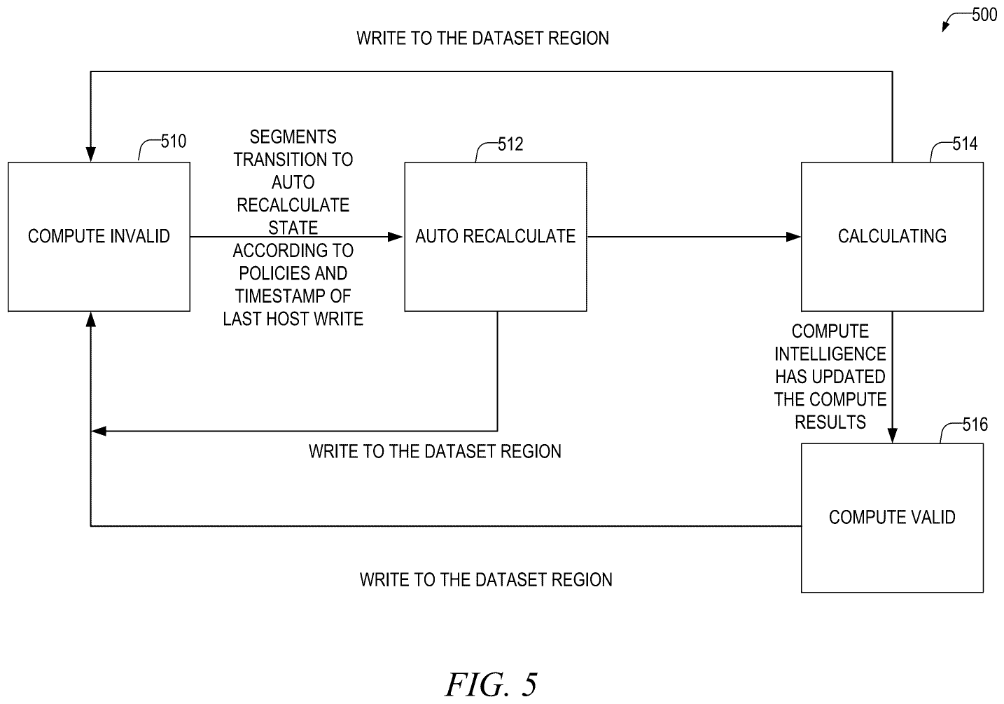

FIG. 5 illustrates a state machine 500 for managing a compute validity bit associated with a compute region segment in a memory device according to some examples of the present disclosure. The state machine ensures that the validity bit is correct to ensure that the host is able to determine the validity of the results. The state machine of the memory device includes the following states: compute invalid state 510—which is the initial state where the compute validity bit is set to indicate that the computational results are not valid or are outdated due to recent writes to the corresponding dataset region segment. The compute validity it is cleared when a write happens to the corresponding data set region. Auto Recalculate state 512: In this state, the memory module is awaiting a trigger to start the recalculation of the computational results. This trigger could be based on a policy that specifies conditions under which recalculation should occur, such as a write to the dataset region segment or a read attempt of an invalid compute validity bit by a host or a write attempt to a compute region. Calculating state 514: Once the trigger condition is met, the state transitions to the calculating state, where the memory device performs the computation using the data from the dataset region segment. During this state, the compute validity bit remains unset. Compute Valid state 516: After the computation is complete, the state transitions to the compute valid state 516, and the compute validity bit is set. This indicates that the computational results are now valid and can be read by the host. A host write to the Dataset Region segment clears the compute validity bit and moves the state to the compute invalid state 510.

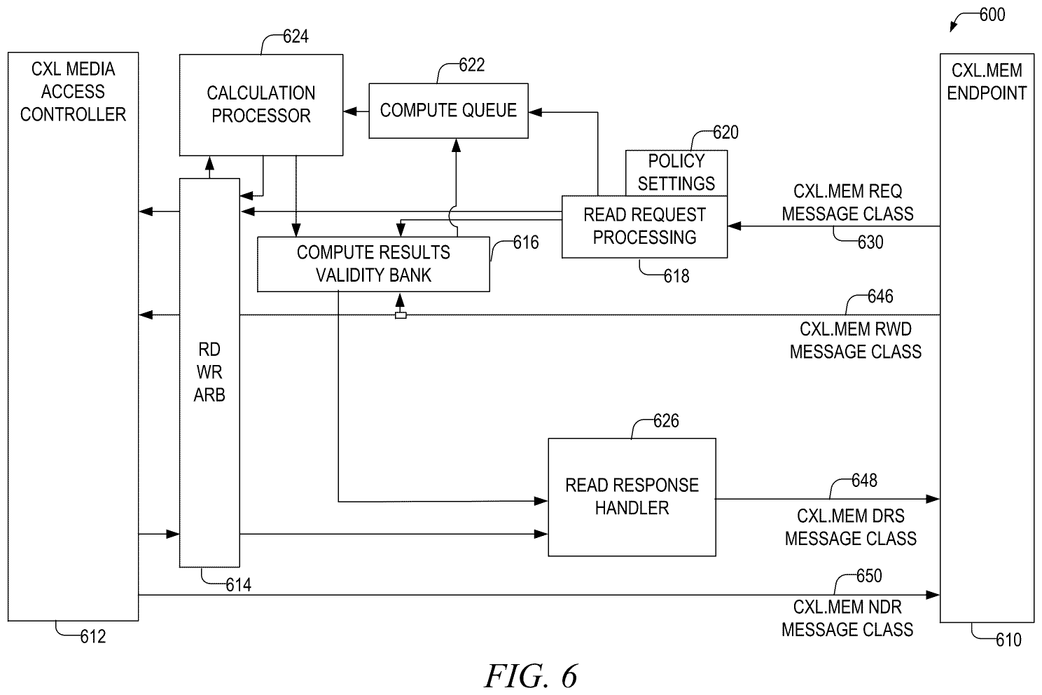

FIG. 6 illustrates a block diagram 600 of the hardware architecture for the Computational Memory Controller within a CXL memory device according to some examples of the present disclosure. The diagram illustrates the flow and processing of memory requests and the interaction between various components that manage computational tasks and memory access. The CXL.mem Endpoint 610 is the interface for the CXL memory device that receives and sends memory access messages. CXL.MEM REQ Message Class 630 shows the path for incoming read requests from the host to the memory device. CXL.mem RwD Message Class 646 shows the flow of request-with-data messages, which are typically write requests containing data to be written to memory. CXL.mem DRS Message Class 648 shows the flow of data response packets (DRS) (e.g., read returns), which are sent from the memory device to the host in response to read requests. CXL.mem non-data response (NDR) Message Class 650 shows the flow of non-data response messages, which are responses from the memory device that do not contain data, such as acknowledgments of write requests.

CXL Media Access Controller 612 manages access to the physical media of the CXL memory device, such as reading from or writing to the memory cells. Read Request Processing 618 intercepts read requests targeting the compute region segments and directs the requests to the appropriate components for processing, such as the compute queue 622—e.g., in accordance with the policy settings 620. For example, if the policy settings indicate that a read request for a particular compute segment triggers the computation of the results, the read request processing may trigger the computation—e.g., by re-ordering the request in the compute queue 622. RD/WR/ARB 614 is the read/write arbiter that manages the prioritization and sequencing of read and write operations to the memory.

Compute Results Validity Bank 616 is an on-die structure that stores the compute validity bits for the compute region segments, indicating whether the computational results are valid. Compute results validity bank 616 may place calculations in the compute queue 622 as a result of received requests for data (e.g., writes to the data set region). Policy settings 620 are the policy settings that determine the behavior of the computational memory, such as when to start new computations or how to prioritize tasks. Calculation processor 624 manages the computation tasks, including initiating and tracking the progress of computations. The results of the computations may be sent to the RD/WR/ARB 614 for writing to the compute region 218.

Compute queue 622 may be a First-In-First-Out (FIFO) queue that holds pending computation tasks, organizing them according to the policy settings before they are processed by the calculation processor 624. Read response handler 626 handles the formation and sending of the read response back to the host, including merging the compute validity bits with the computational results after a read request is processed.

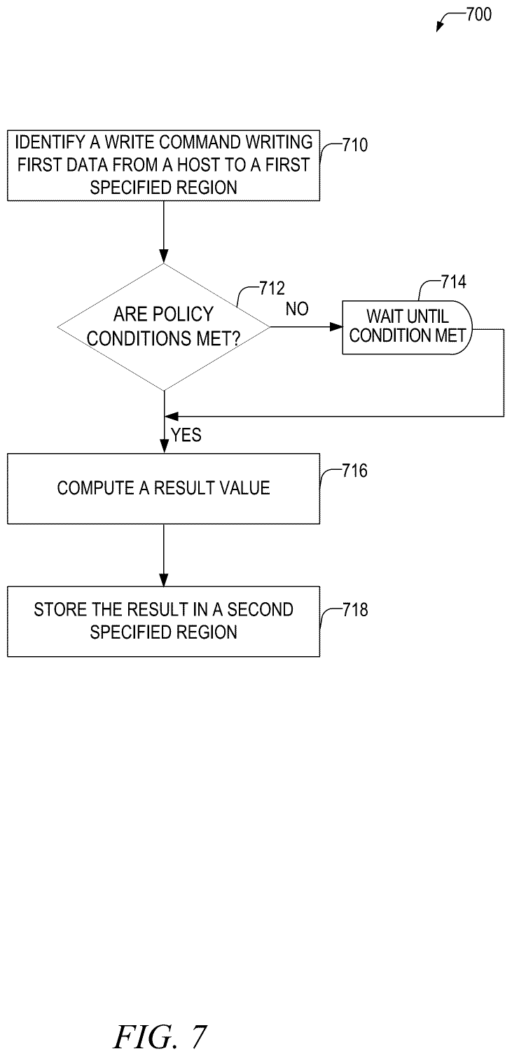

FIG. 7 illustrates a flowchart of a method 700 of computational memory processing according to some examples of the present disclosure. At operation 710 the memory device, e.g., the controller, may receive a write request from a host writing first data from a host to a first specified region. For example, writing data to the dataset region 220. At operation 712 a determination is made whether the policy conditions are met. If not, then at operation 714 the method pauses until the policy conditions are met. Once the policy conditions are met, then at operation 716 the result value is computed. In some examples, operation 712 is met by the write to the first specified region. At operation 718 once the result value is computed, then it is stored in a second specified region, such as a segment of a compute region corresponding to the segment of the first specified region where the write command was directed at operation 710.

In some examples, the region pairs are configured using management messages, such as CXL management mailbox protocols. Settings may include:

| Region Pair State | Comment |
|---|---|
| Dataset Region: | The Dataset Region may be physically |
| Starting Address | contiguous. |
| Dataset Region: | The size of each segment in the dataset region. |
| Segment Size | In some examples, all segments in a region may |
| | be the same size. For example, 4 KB, 2 MB, |
| | 1 GB, or the like. |
| Number of Segments | In some examples, the dataset region and compute |
| (dataset and compute) | region have the same number of segments |
| Compute Region: | The Compute Region may be physically |
| Starting Address | contiguous. |
| Compute Region: | The size of each segment in the compute |
| Segment Size | region. |
| Compute Algorithm | The algorithm used for the compute. An |
| | implementation might choose to only support a |
| | collection of algorithms all pre-loaded into |
| | the memory device or the code might be passed |
| | as a part of the mailbox command which sets |
| | up a Computation Memory Region Pair. |
| | The actual source code may be stored |
| | local to the CXL memory device, |
| | but not visible to the hosts. |
| Compute Minimum | The fastest a new computation can be performed |
| Recalculation Period | for a segment. |
| Compute Start Policy | Some example policies include: |
| | Compute new results immediately after |
| | write to dataset segment. |
| | Compute after a write to a data set region and |
| | no write to the region in the last N |
| | milliseconds |
| | Compute after a host reads an invalid compute |
| | validity bit. |
| | Compute after a write to a compute region |
| | segment is received. |

In some examples, certain operations on the dataset and compute regions may be restricted. For example:

| Proces- | | | |
|---|---|---|---|
| sor | Access | Dataset Regions | Compute Regions |
| Host | Reads | Yes | Yes: Reads may be stalled |
| | | | momentarily if a CXL |
| | | | Module Compute is writing |
| | | | to the same Segment at |
| | | | the same time. |
| | Writes | Yes: Multi-host software | No: Writes are silently |
| | | cache coherency requires | dropped. |
| | | only one writing host at | |
| | | any given time | |
| CXL | Read | Yes | Implementation dependent |
| Module | Write | No: CXL software and/or | Yes: This is where the |
| | | hardware stop the CXL | computation results |
| | | module's processor | are put. |
| | | from writing to the | |
| | | dataset region | |

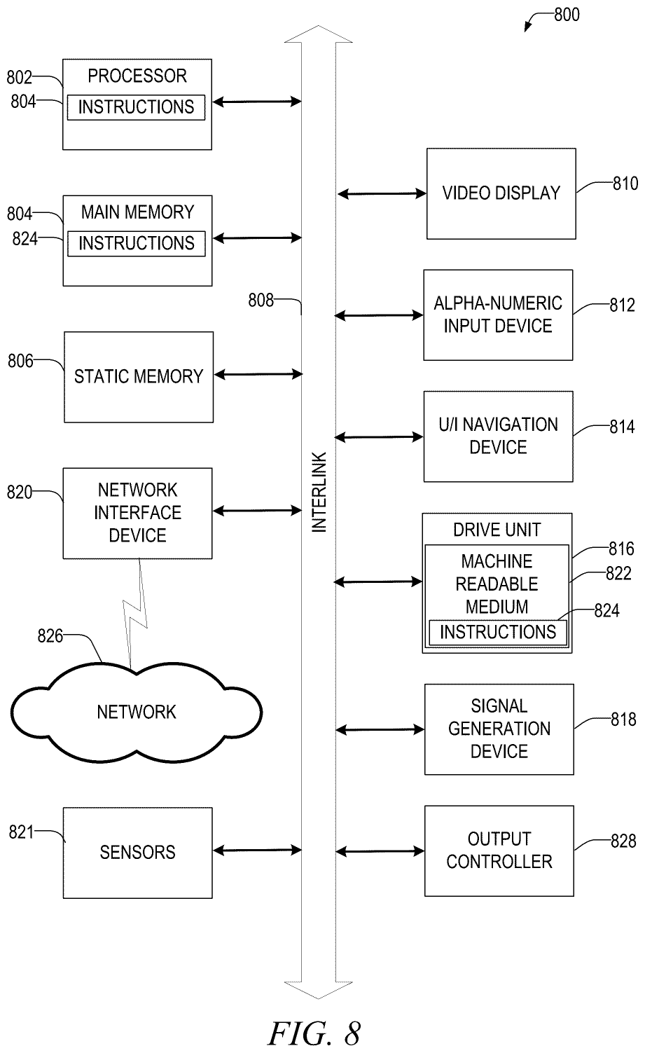

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) environment or other distributed network environments. The machine 800 may be in the form of a distributed computing system, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations. In some examples, the machine 800 may include one or more of the memory devices described herein. In some examples, the memory devices described herein may include one or more of the components of the machine 800. For example, the machine 800 may be, be configured as, or one or more components of machine 800 may make up, one or more hosts such as host 110-A, 110-B-110-P; fabric nodes of fabric 112, memory devices 114-A, 114-B . . . 114-N of FIG. 1. Machine 800 may be, be configured as, or one or more components of machine 800 may make up, host B 210, host A 212, memory device 216, and fabric manager 214 of FIG. 2. Machine 800 may include memory configured as shown in FIG. 3. Machine 800 may be configured to do memory computations as shown in FIG. 4 and implement the state machine of FIG. 5. Machine 800 may be, be configured as, or one or more components of machine 800 may make up the components of FIG. 6 and may be configured to perform the method of FIG. 7.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 800 may include one or more hardware processors, such as processor 802. Processor 802 may be a central processing unit (CPU), a graphics processing unit (GPU), a hardware processor core, or any combination thereof. Machine 800 may include a main memory 804 and a static memory 806, some or all of which may communicate with each other via an interlink (e.g., bus) 808. Examples of main memory 804 may include Synchronous Dynamic Random-Access Memory (SDRAM), such as Double Data Rate memory, such as DDR4 or DDR5. Interlink 808 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### ADDITIONAL NOTES AND EXAMPLES

Example 1 is a memory device, comprising: memory storage including a first region and a second region; a memory controller, the memory controller configured to perform operations comprising: identifying a write command writing first data from a host to the first region; responsive to identifying the write command writing first data from the host to the first region, computing a result value, the result value computed by using the first data; and responsive to computing the result value, storing the result value in the second region.

In Example 2, the subject matter of Example 1 includes, wherein the operations of computing the result value and storing the result value is done in accordance with a specified policy.

In Example 3, the subject matter of Example 2 includes, wherein the specified policy comprises one of: an indication that the memory device is to immediately compute the result value immediately after the write command; an indication that the memory device is to compute the result value if no other writes are received within a specified amount of time; an indication that the memory device is to compute the result value immediately after an attempt by the host to read a valid bit; or an indication that the memory device is to compute the result value after a write to the second region.

In Example 4, the subject matter of Examples 1-3 includes, wherein the memory controller is further configured to perform the operations of clearing a valid bit upon identifying the write command and setting the valid bit upon storing the result value.

In Example 5, the subject matter of Example 4 includes, wherein the memory controller is further configured to perform the operations of waiting to set the valid bit until the result value is stored and a prespecified amount of time has passed since the valid bit was previously set.

In Example 6, the subject matter of Examples 1-5 includes, wherein the specified algorithm is selected by the host from one of a plurality of prespecified algorithms.

In Example 7, the subject matter of Examples 1-6 includes, wherein the specified algorithm is supplied by the host.

Example 8 is a method for operating a memory device including memory storage with a first region and a second region, the method comprising: identifying a write command writing first data from a host to the first region; responsive to identifying the write command writing first data from the host to the first region, computing a result value, the result value computed by using the first data; and responsive to computing the result value, storing the result value in the second region.

In Example 9, the subject matter of Example 8 includes, wherein computing the result value and storing the result value is done in accordance with a specified policy.

In Example 10, the subject matter of Example 9 includes, wherein the specified policy comprises one of: an indication that the memory device is to immediately compute the result value immediately after the write command; an indication that the memory device is to compute the result value if no other writes are received within a specified amount of time; an indication that the memory device is to compute the result value immediately after an attempt by the host to read a valid bit; or an indication that the memory device is to compute the result value after a write to the second region.

In Example 11, the subject matter of Examples 8-10 includes, clearing a valid bit upon identifying the write command and setting the valid bit upon storing the result value.

In Example 12, the subject matter of Example 11 includes, setting the valid bit until the result value is stored and a prespecified amount of time has passed since the valid bit was previously set.

In Example 13, the subject matter of Examples 8-12 includes, wherein the specified algorithm is selected by the host from one of a plurality of prespecified algorithms.

In Example 14, the subject matter of Examples 8-13 includes, wherein the specified algorithm is supplied by the host.

Example 15 is a non-transitory machine-readable medium, storing instructions, which when executed by a memory controller of a memory device including memory storage with a first region and a second region cause the memory controller to perform operations comprising: identifying a write command writing first data from a host to the first region; responsive to identifying the write command writing first data from the host to the first region, computing a result value, the result value computed by using the first data; and responsive to computing the result value, storing the result value in the second region.

In Example 16, the subject matter of Example 15 includes, wherein computing the result value and storing the result value is done in accordance with a specified policy.

In Example 17, the subject matter of Example 16 includes, wherein the specified policy comprises one of: an indication that the memory device is to immediately compute the result value immediately after the write command; an indication that the memory device is to compute the result value if no other writes are received within a specified amount of time; an indication that the memory device is to compute the result value immediately after an attempt by the host to read a valid bit; or an indication that the memory device is to compute the result value after a write to the second region.

In Example 18, the subject matter of Examples 15-17 includes, clearing a valid bit upon identifying the write command and setting the valid bit upon storing the result value.

In Example 19, the subject matter of Example 18 includes, setting the valid bit until the result value is stored and a prespecified amount of time has passed since the valid bit was previously set.

In Example 20, the subject matter of Examples 15-19 includes, wherein the specified algorithm is selected by the host from one of a plurality of prespecified algorithms.

In Example 21, the subject matter of Examples 15-20 includes, wherein the specified algorithm is supplied by the host.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A memory device, comprising:
memory storage including a first region and a second region;
a memory controller, the memory controller configured to perform operations comprising:
identifying a write command writing first data from a host to the first region;
responsive to identifying the write command writing first data from the host to the first region, computing a result value, the result value computed by using the first data; and
responsive to computing the result value, storing the result value in the second region.

2. The memory device of claim 1, wherein the operations of computing the result value and storing the result value is done in accordance with a specified policy.

3. The memory device of claim 2, wherein the specified policy comprises one of: an indication that the memory device is to immediately compute the result value immediately after the write command; an indication that the memory device is to compute the result value if no other writes are received within a specified amount of time; an indication that the memory device is to compute the result value immediately after an attempt by the host to read a valid bit; or an indication that the memory device is to compute the result value after a write to the second region.

4. The memory device of claim 1, wherein the memory controller is further configured to perform the operations of clearing a valid bit upon identifying the write command and setting the valid bit upon storing the result value.

5. The memory device of claim 4, wherein the memory controller is further configured to perform the operations of waiting to set the valid bit until the result value is stored and a prespecified amount of time has passed since the valid bit was previously set.

6. The memory device of claim 1, wherein the specified algorithm is selected by the host from one of a plurality of prespecified algorithms.

7. The memory device of claim 1, wherein the specified algorithm is supplied by the host.

8. A method for operating a memory device including memory storage with a first region and a second region, the method comprising:
identifying a write command writing first data from a host to the first region;
responsive to identifying the write command writing first data from the host to the first region, computing a result value, the result value computed by using the first data; and
responsive to computing the result value, storing the result value in the second region.

9. The method of claim 8, wherein computing the result value and storing the result value is done in accordance with a specified policy.

10. The method of claim 9, wherein the specified policy comprises one of: an indication that the memory device is to immediately compute the result value immediately after the write command; an indication that the memory device is to compute the result value if no other writes are received within a specified amount of time; an indication that the memory device is to compute the result value immediately after an attempt by the host to read a valid bit; or an indication that the memory device is to compute the result value after a write to the second region.

11. The method of claim 8, further comprising clearing a valid bit upon identifying the write command and setting the valid bit upon storing the result value.

12. The method of claim 11, further comprising setting the valid bit until the result value is stored and a prespecified amount of time has passed since the valid bit was previously set.

13. The method of claim 8, wherein the specified algorithm is selected by the host from one of a plurality of prespecified algorithms.

14. The method of claim 8, wherein the specified algorithm is supplied by the host.

15. A non-transitory machine-readable medium, storing instructions, which when executed by a memory controller of a memory device including memory storage with a first region and a second region cause the memory controller to perform operations comprising:
identifying a write command writing first data from a host to the first region;
responsive to identifying the write command writing first data from the host to the first region, computing a result value, the result value computed by using the first data; and
responsive to computing the result value, storing the result value in the second region.

16. The non-transitory machine-readable medium of claim 15, wherein computing the result value and storing the result value is done in accordance with a specified policy.

17. The non-transitory machine-readable medium of claim 16, wherein the specified policy comprises one of: an indication that the memory device is to immediately compute the result value immediately after the write command; an indication that the memory device is to compute the result value if no other writes are received within a specified amount of time; an indication that the memory device is to compute the result value immediately after an attempt by the host to read a valid bit; or an indication that the memory device is to compute the result value after a write to the second region.

18. The non-transitory machine-readable medium of claim 15, further comprising clearing a valid bit upon identifying the write command and setting the valid bit upon storing the result value.

19. The non-transitory machine-readable medium of claim 18, further comprising setting the valid bit until the result value is stored and a prespecified amount of time has passed since the valid bit was previously set.

20. The non-transitory machine-readable medium of claim 15, wherein the specified algorithm is selected by the host from one of a plurality of prespecified algorithms.
